(19) United States
(12) Patent Application Publication
(10) Pub. No.: US 2009/0013976 A1
(43) Pub. Date: Jan. 15, 2009

(54) MAGNETIC PROCESSING EQUIPMENT FOR ENGINE AND MAGNETIC PROCESSING SYSTEM FOR ENGINE

(76) Inventor: Masahiro Mori, Shizuoka-Prefecture (JP)

Correspondence Address: BURR & BROWN, PO BOX 7068, SYRACUSE, NY, 13261-7068, US

(21) Appl. No.: 11/574,042

(22) PCT Filed: Aug. 24, 2004
(86) PCT No.: PCT/JP04/12349

§ 371 Date: Feb. 21, 2007

(51) Int. Cl. F02M 27/04; F02M 37/22

(52) U.S. Cl. 123/538; 123/536

(57) ABSTRACT

When fuel passing through a fuel supply line and intake air passing through an air intake line are magnetically treated, magnetic reactions of the fuel and intake air are enhanced, and efficiency of the magnetic treatment is enhanced. A magnetic treatment apparatus for an engine which is provided in a fuel supply line and an air intake line of an engine, and performs magnetic treatment for fuel and intake air includes a magnet pair constituted of a pair of magnets opposed to each other with a pipe (the aforesaid fuel supply line and air intake line), and generating magnetic flux in a direction perpendicular to flows of the fuel and the intake air, and a casing covering the magnet pair, and has the constitution in which the casing accommodates a plurality of magnet pairs, and the magnet pairs are disposed along the pipe at predetermined spaces.

### BACKGROUND OF THE INVENTION

1. Field of the Invention

The present invention relates to a magnetic treatment apparatus for an engine, which is provided in a fuel supply line and/or an air intake line of an engine, and performs magnetic treatment for fuel passing through the fuel supply line and intake air passing through the air intake line, and a magnetic treatment system for an engine, and particularly relates to a magnetic treatment apparatus for an engine and a magnetic treatment system for an engine which can efficiently perform magnetic treatment of fuel and intake air and can prevent leakage of magnetic flux.

2. Description of the Related Art

In recent years, it is proposed to magnetically treat fuel and intake air for the purpose of enhancement of combustion efficiency and purification of exhaust gas in an engine (For example, see Patent Document 1.).

As the apparatus for performing magnetic treatment of this kind, the one utilizing an MHD (Magnet HydroDynamics) effect is widely known, and the principle is as follows.

FIG. 8 is an explanatory view showing the principle of the magnetic treatment.

As shown in FIG. 8, the magnetic treatment apparatus usually includes a pair of permanent magnets 1 opposed to each other with a flow path for an object to be magnetically treated therebetween, and generates magnetic flux in the direction perpendicular to the flow of the object to be magnetically treated. More preferably, a pair of nonmagnetic conductor metal plates 2 are disposed to sandwich the magnetic flux. The nonmagnetic conductor metal plate 2 rectifies the magnetic flux, increases the magnetic flux density, stores electrons, and the like.

When the magnetic flux in the direction perpendicular to the flow of the object to be magnetically treated is generated as described above, magnetic reaction occurs to the electrons in the object to be magnetically treated when the object to be magnetically treated passes through the magnetic flux. By the magnetic reaction, the action which fragments the chains of molecules acts on the object to be magnetically treated.

For example, the form of the hydrocarbon to be fuel is a lump (cluster) in a long chain shape, and therefore, hydrocarbon in that form not only causes imperfect combustion to reduce combustion efficiency, but also discharges harmful substances such as unburnt hydrocarbon, a carbon monoxide and a lo nitrogen oxide. However, hydrocarbon fragmented by the magnetic treatment is combusted efficiently, and therefore, it makes it possible to enhance fuel efficiency and purify exhaust gas.

When the intake air of the engine is magnetically treated, oxygen is activated by the magnetic reaction, and therefore, it is made possible to combust fuel efficiently.

As the apparatuses performing magnetic treatment for fuel or the like by utilizing the principle, those disclosed in Patent Documents 1 to 3 are cited.

[Patent Document 1] Japanese Patent Application Laid-open No. 11-333286

[Patent Document 2] Japanese Patent Application Laid-open No. 7-77323

[Patent Document 3] Japanese Patent Application Laid-open No. 6-58525

In recent years, in the magnetic treatment apparatus as described above, it is proposed to use a rare-earth magnet such as a neodymium magnet (neodymium-iron-boron magnet) in order to generate a strong magnetic field (high-density magnetic flux).

Use of such a strong magnet enhances the magnetic reaction of the object to be magnetically treated, but when the flow of the object to be treated is fast, it causes the problem that the time in which magnetism acts on the object to be magnetically treated is insufficient, and a sufficient effect cannot be obtained.

Especially because the fuel does not have uniform shapes of clusters, even if the magnetic field of the magnetic treatment is simply made strong, long clusters are likely to remain to cause incomplete combustion.

Further, when a strong magnet is used, countermeasures against leakage flux is required.

In the magnetic treatment apparatus shown in Patent Document 1, magnetic flux is caused to converge in the apparatus by utilizing the case as a part of the magnetic circuit, and such a magnetic treatment apparatus has the disadvantage of being unable to be mounted near a ferromagnetic substance. Namely, if the case is brought close to a ferromagnetic substance, the magnetic circuit is short-circuited, and therefore, there arises the problem of occurrence of flux leakage.

Patent Document 2 describes that it has an object to provide a combustion efficiency enhancing apparatus for liquid fuel which can accelerate atomization of fuel by constructing an electromagnetic wave passage forming a multipolar and multiaxial magnetic flux pattern by a plurality of multipolar magnetic arrays, and according to FIG. 2 of Japanese Patent Application Laid-open No. 7-77323, permanent magnet pairs are equidistantly and continuously disposed with respect to the conduit.

In Patent Document 3, permanent magnet pairs are disposed at spaces in the axial direction of the fuel pipe.

Accordingly, it seems that the effect of intermittently applying the magnetic action to the liquid fuel passing through the conduit is recognized.

However, the permanent magnets of Patent Document 2 are disposed so that the magnetic flux inside the conduit concentrates, and the permanent magnets are not disposed at predetermined spaces that intermittently apply the magnetic action of the invention of the present application.

Patent Document 3 describes that in order to obtain the effect of concentration of the magnetic flux inside the conduit, a soft magnetic material such as iron is disposed between each of the permanent magnets and the permanent magnets, and thereby, the effect of intermittently applying the magnetic action cannot be expected.

### SUMMARY OF THE INVENTION

The present invention is made in view of the above described circumstances, and has an object to provide a magnetic treatment apparatus for an engine and a magnetic treatment system for an engine which can enhance magnetic reaction of fuel and intake air and can enhance the efficiency of magnetic treatment by causing magnetism to act on the fuel and intake air intermittently when magnetically treating the fuel passing through a fuel supply line and the intake air passing through an air intake line.

In order to attain the above described object, a magnetic treatment apparatus for an engine of the present invention is a magnetic treatment apparatus for an engine which is provided in a fuel supply line and/or an air intake line of an engine and performs magnetic treatment for fuel passing through said fuel supply line and/or intake air passing through said air intake line, includes a magnet pair constituted of a pair of magnets opposed to each other with the aforesaid fuel supply line and/or the aforesaid air intake line therebetween, and generating magnetic flux in a direction substantially perpendicular to a flow of the fuel and/or the intake air, and a casing covering the aforesaid magnet pair, and is constituted so that the aforesaid casing accommodates a plurality of the aforesaid magnet pairs, and the aforesaid magnet pairs are disposed along the aforesaid fuel supply line and/or the aforesaid air intake line at predetermined spaces by which the aforesaid magnet pairs intermittently apply a magnetic action. In this case, the aforesaid magnets are preferably disposed to be opposed to each other at both sides of a pipe made of a nonmagnetic material in the fuel supply line and/or the air intake line of the engine.

By constructing the magnetic treatment apparatus for an engine as above, the fuel passing through the fuel supply line (pipe), the intake air passing through the air intake line (pipe) pass the magnetic field generated by the magnet pairs at least a plurality of times, and are intermittently subjected to the magnetic action. Thereby, not only the magnetic reactions of the fuel and intake air can be enhanced, but also the efficiency of the magnetic treatment can be enhanced.

For example, the fuel including molecules in a long cluster state hardly has a sufficiently small molecular state by only one magnetic treatment, but according to the magnetic treatment apparatus for an engine of the present invention, by causing high-density magnetic flux to act intermittently on the fuel, fragmentation of the cluster is accelerated, and the fuel has the molecular state with high combustion efficiency.

Further, the magnetic treatment apparatus for an engine of the present invention is constructed so that a side surface and a rear surface of the aforesaid magnet are covered with a yoke formed of a ferroelectric metal, and the aforesaid magnets are covered with a magnetic shield.

By constructing the magnetic treatment apparatus for an engine like this, leakage of magnetic flux can be prevented by the magnetic shield even if a plurality of magnet pairs are provided and the residual magnetic flux density of the magnet is enhanced.

As the magnetic shield, a ferromagnetic metal such as iron, for example, can be used.

Further, in the magnetic treatment apparatus for an engine of the present invention, the aforesaid magnet is a rare-earth permanent magnet having a residual magnetic flux density of 10000 gausses or more. As the rare-earth magnet, for example, a neodymium magnet can be used.

Here, the residual magnetic flux densities of the aforesaid magnet pairs are preferably made substantially the same.

Further, the magnetic treatment apparatus for an engine of the present invention is constructed so that the aforesaid magnet pairs are disposed at spaces each of which is twice to ten times as large as a diameter of the aforesaid pipe. This allows magnetism to act reliably in the intermittent state.

Further, a width of the aforesaid magnet is designed to be larger than a diameter of the aforesaid pipe. This allows magnetism to act sufficiently on the entire pipe in the diameter direction of the pipe, and therefore, accelerates decomposition of the clusters.

Further, the magnetic treatment apparatus for an engine of the present invention is constructed so that the aforesaid casing is formed of a nonmagnetic resin material. By constructing the magnetic treatment apparatus for an engine like this, magnetic flux leakage can be reliably prevented because the magnetic circuit inside the apparatus is not short-circuited even if the magnetic treatment apparatus is mounted near a ferromagnetic substance. As the nonmagnetic resin material, for example, FRP (fiber reinforced plastic) can be used.

Further, the magnetic treatment apparatus for an engine of the present invention is constructed so that the aforesaid magnetic shield is formed by using a ferromagnetic metal plate material which is bent to be U-shaped in section.

By constructing the magnetic treatment apparatus for an engine like this, the magnetic shield can be formed by simple work by using a less expensive ferromagnetic metal plate material such as an iron plate, and therefore, the manufacturing cost of the magnetic treatment apparatus can be reduced.

Further, in order to attain the above described object, a magnetic treatment system for an engine of the present invention is constructed so that the aforesaid magnetic treatment apparatus for an engine is provided in the fuel supply line of an engine and/or the air intake line of the engine.

By constructing the magnetic treatment system for an engine like this, magnetic treatment can be performed for the fuel and the intake air at the same time or for any one of them, and it is made possible to enhance the combustion efficiency of the fuel in the engine synergistically.

As above, according to the present invention, the magnetic treatment apparatus for an engine can enhance magnetic reactions of fuel and intake air, and can enhance the efficiency of magnetic treatment by causing magnetism to act on the fuel and intake air intermittently when magnetically treating the fuel passing through the fuel supply line and the intake air passing through the air intake line.

Further, the aforesaid magnetic treatment apparatus for an engine is provided in the fuel supply line of the engine and/or the air intake line of the engine, and magnetically treats the fuel and intake air at the same time, and thereby, the fuel combustion efficiency in the engine can be enhanced synergistically.

### BRIEF DESCRIPTION OF THE DRAWINGS

FIG. 1 is a block diagram showing the construction of a magnetic treatment system for an engine;

FIG. 2 is a plane view of a magnetic treatment apparatus for an engine;

FIG. 3 is a side view of the magnetic treatment apparatus for an engine;

FIG. 4 is a front view of the magnetic treatment apparatus for an engine;

FIG. 5 is a sectional view of the magnetic treatment apparatus for an engine;

FIG. 6 is a sectional view of the magnetic treatment apparatus for an engine in which a yoke section is formed into a square shape;

FIG. 7 is a system block diagram showing one example of the state in which the magnetic treatment apparatuses for an engine are disposed in series and in parallel; and

FIG. 8 is an explanatory view showing the principle of the magnetic treatment.

### [Explanation of Codes]

10 ENGINE

20 FUEL SUPPLY SYSTEM

21 FUEL TANK

22 FUEL FILTER

23 FUEL SUPPLY LINE

30 AIR INTAKE SYSTEM

31 AIR FILTER

32 AIR INTAKE LINE

40 EXHAUST SYSTEM

41 MUFFLER

50 MAGNETIC TREATMENT APPARATUS

51 PIPE

52 PERMANENT MAGNET

53 MAGNET PAIR

54, 54a YOKE

55 MAGNETIC SHIELD

55a FERROMAGNETIC METAL PLATE MATERIAL

56 CASING

56a BASE PART

56b COVER PART

### DETAILED DESCRIPTION OF THE PREFERRED EMBODIMENT(S)

An embodiment of the present invention will now be described with reference to the drawings.

### [Magnetic Treatment System for Engine]

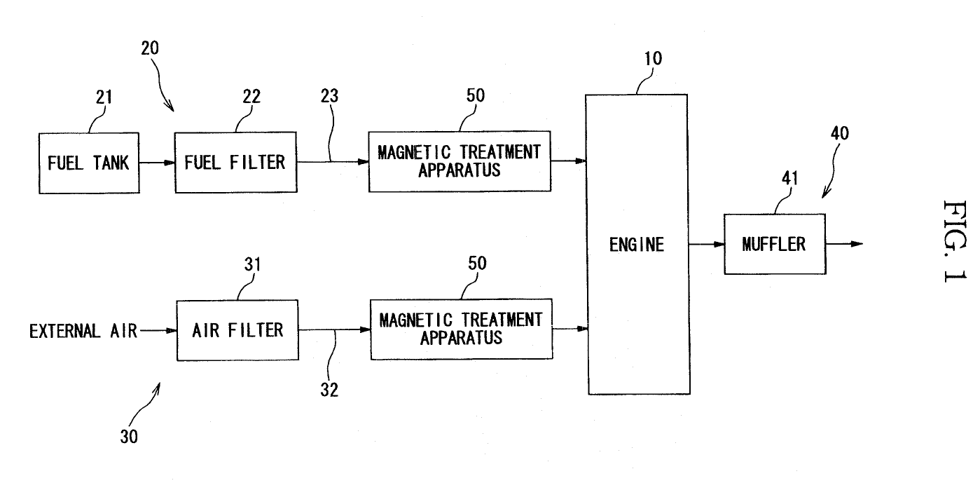

First, a magnetic treatment system for an engine of the present invention will be described with reference to FIG. 1.

FIG. 1 is a block diagram showing the construction of the magnetic treatment system for an engine.

As shown in the drawing, a fuel supply system 20, an air intake system 30 and an exhaust system 40 are connected to an engine 10.

The fuel supply system 20 is constructed by including a fuel tank 21 storing fuel such as gasoline and light oil, a fuel filter 22 for filtering fuel, and a fuel supply line (fuel supply pipe) 23 extending from the fuel tank 21 to the engine 10.

The air intake system 30 is constructed by including an air filter 31 for filtering intake air for the engine 10, and an air intake line (air intake pipe) 32 which guides the filtered intake air to the engine 10.

The engine 10 guides the fuel supplied from the fuel supply system 20 and the intake air supplied from the air intake system 30 into a cylinder, and combusts (explodes) them in the compressed state, thereby rotating a crankshaft.

The gas after combustion is discharged through the exhaust system 40. The exhaust system 40 is provided with a muffler 41 for deadening exhaust noise.

The magnetic treatment system for an engine of the present invention is constructed by including a magnetic treatment apparatus 50 provided in the fuel supply line 23, and a magnetic treatment apparatus 50 provided in the air intake line 32.

It is possible to provide the magnetic treatment apparatus 50 which magnetically treats fuel in an arbitrary position on the fuel supply line 23.

A plurality of magnetic treatment apparatuses 50 may be provided in each of the lines 23 and 32, and in this case, a plurality of magnetic treatment apparatuses 50 are connected in series.

The magnetic treatment apparatus 50 is constructed to generate magnetic flux in the direction perpendicular to the flows of the fuel and intake air, and the action that fragments the chains of molecules acts on the fuel and the intake air passing through the magnetic flux by magnetic reactions.

Namely, if fuel is magnetically treated, the cluster of hydrocarbon is fragmented, and the fuel has the molecular state with high combustion efficiency. If intake air is magnetically treated, oxygen is activated by magnetic reaction and combustion efficiency of fuel is enhanced.

The magnetic treatment system for an engine of the present invention synergistically enhances the combustion efficiency of the fuel in the engine 10 by magnetically treating the fuel and intake air at the same time or any one of the fuel and the intake air.

In the magnetic treatment system for an engine of the present invention, in the case of having a reflux pipe (not shown) which returns fuel to the fuel tank 21 from the engine 10 as in, for example, a diesel engine, one or a plurality of magnetic treatment apparatuses can be disposed at the reflux pipe.

### [Magnetic Treatment Apparatus for Engine]

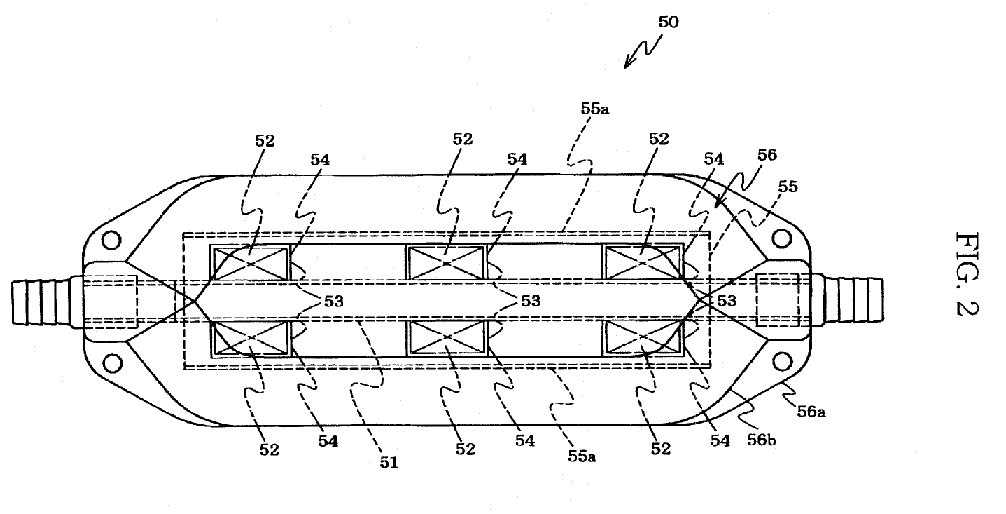

Next, the magnetic treatment apparatus 50 for an engine of the present invention will be described with reference to FIGS. 2 to 5.

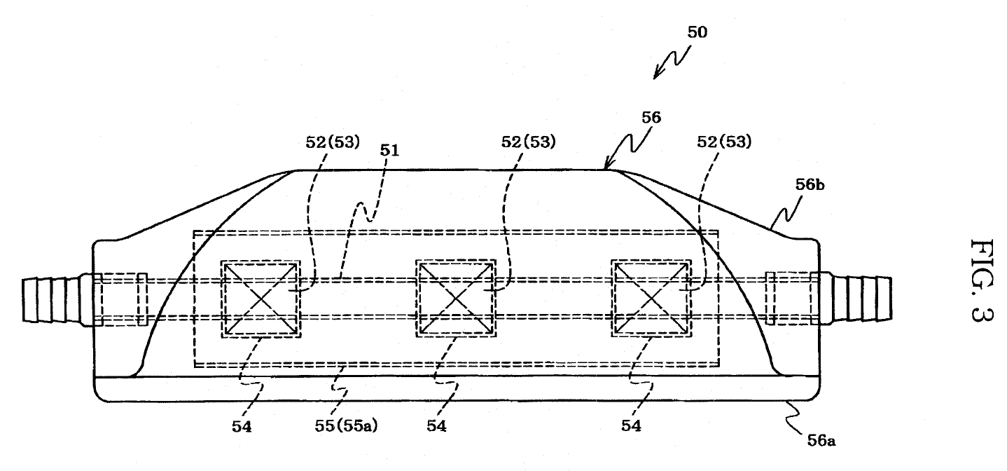

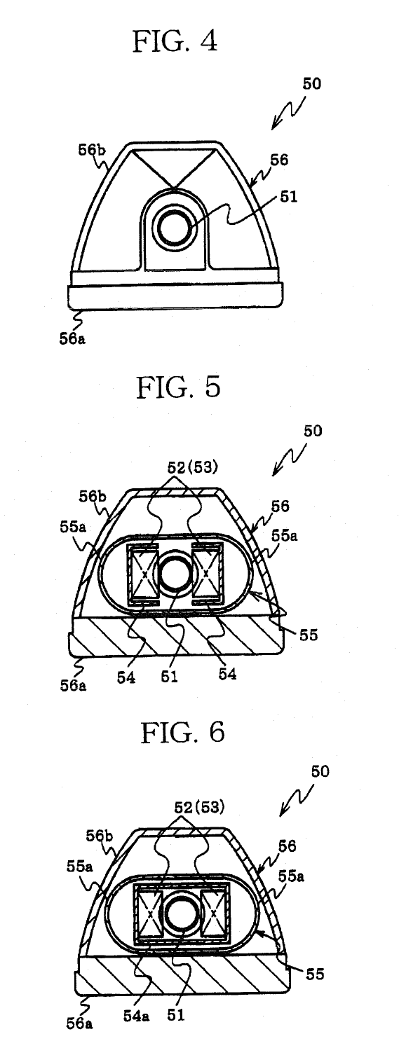

FIG. 2 is a plane view of the magnetic treatment apparatus for an engine, FIG. 3 is a side view of the magnetic treatment apparatus for an engine, FIG. 4 is a front view of the magnetic treatment apparatus for an engine and FIG. 5 is a sectional view of the magnetic treatment apparatus for an engine.

As shown in the drawings, the magnetic treatment apparatus 50 is constructed by including a pipe 51 which penetrates through an apparatus center portion, magnet pairs 53 each constituted of a pair of magnets 52, yokes 54 which hold the magnets 52, a magnetic shield 55 which covers the magnet pairs 53 and the yokes 54, and a casing 56 which covers the entire apparatus.

The pipe 51 is formed of a nonmagnetic substance such as, for example, copper, a copper alloy, aluminum, an aluminum alloy, and a nonmagnetic stainless steel which allows magnetic flux to pass through it. The diameter of the pipe 51 differs depending on the size of the engine, and in the case of an automobile engine, the pipe with a diameter of, for example, 9 mm, 12 mm or 15 mm is used.

When the magnetic treatment apparatus 50 is provided in the fuel supply system 20, the pipe 51 is interposed in a proper position of the fuel supply line 23, and both end portions thereof are connected to the fuel supply line 23 by using the connecting tools such as hose bands to make the pipe 51 the fuel flow path.

When the magnetic treatment apparatus 50 is provided in the air intake system 30, the pipe 51 is interposed in a proper position of the air intake line 32, and both end portions thereof are connected to the air intake line 32 by using connecting tools to make the pipe 51 the air intake flow path.

A permanent magnet or an electromagnet can be used as the magnet 52, and in the case of a permanent magnet, the magnet 52 is preferably a rare-earth magnet which generates magnetic flux with a high density of 10000 gausses or more.

When an electromagnet is used as the magnet 52, a magnetic field with arbitrary strength can be formed within the range of about 10000 to 25000 gausses. Accordingly, the strength of the magnetic field can be regulated in accordance with the amount of fuel and/or intake air.

In this embodiment, the case using a permanent magnet, for example, a neodymium magnet (neodymium-iron-boron magnet) having a residual magnetic flux density of 12000 gausses is shown.

The size of the permanent magnet 52 is preferably made wider than the diameter of the pipe 51. In this embodiment, the size of the magnet is 24 mm wide by 24 mm long by 14 mm thick with respect to the pipe 51 with the diameter of 9 mm, 12 mm or 15 mm.

With this size, whole of the pipe 51 in the diameter direction is covered with the permanent magnet 52 to cause the magnetic field to act thereon, and the magnetic field can be also caused to act to the pipe 51 in the lengthwise direction with the sufficient distance.

A pair of permanent magnets 52 constituting the magnet pair 53 are disposed so that the south pole and the north pole are opposed to each other at 180 degrees in the lateral direction with the pipe 51 therebetween. Between a pair of the permanent magnets 52 (12000 gausses×2=24000 gausses), the magnetic flux in the direction perpendicular to the flows of the fuel and intake air occurs, and the fuel and intake air are magnetically treated by passing through the magnetic flux.

The magnetic treatment apparatus 50 of the present invention includes a plurality (three pairs in this embodiment) of magnet pairs 53, and these magnet pairs 53 are disposed along the pipe 51 at predetermined spaces. If the space between the magnet pairs 53 is too short, decomposition by intermittent magnetic action cannot be performed, and if the space between the magnet pairs 53 is long, recombination of the decomposed molecules is brought about.

In the pipe 51 of a diameter of 9 mm, 12 mm or 15 mm of this embodiment, the space between the magnet pairs is preferably set as shown in the following Table 1, for example.

TABLE 1

| PIPE DIAMETER d (mm) | 9 | 12 | 15 |
|---|---|---|---|
| MAGNET PAIR SPACE s (mm) | 30~90 | 30~120 | 30~150 |
| s/d | 3.3~10 | 2.5~10 | 2.0~10 |

Thereby, the fuel and intake air flowing through the pipe 51 pass through the magnetic fields generated by the magnet pairs 53 a plurality of times, and are intermittently subjected to the magnetic action in a pulse form. If the magnetic action is intermittently applied to the fuel and air supplied to the engine like this, recombination of the molecules decomposed by the previous magnetic action is prevented, and the residual clusters which are decomposed by the previous magnetic action, but still remain as small clusters are further decomposed reliably.

In the fuel including long cluster molecules, fragmentation of the clusters are accelerated by a plurality of intermittent magnetic treatment actions, and the fuel has the molecular form with high combustion efficiency. A plurality of magnet pairs 53 opposed to each other at 180 degrees preferably have the polarities in the same direction. This causes the magnetic field in the same direction to act intermittently to the fuel flowing in the pipe, accelerates decomposition of the cluster, and makes the clusters easily decomposable.

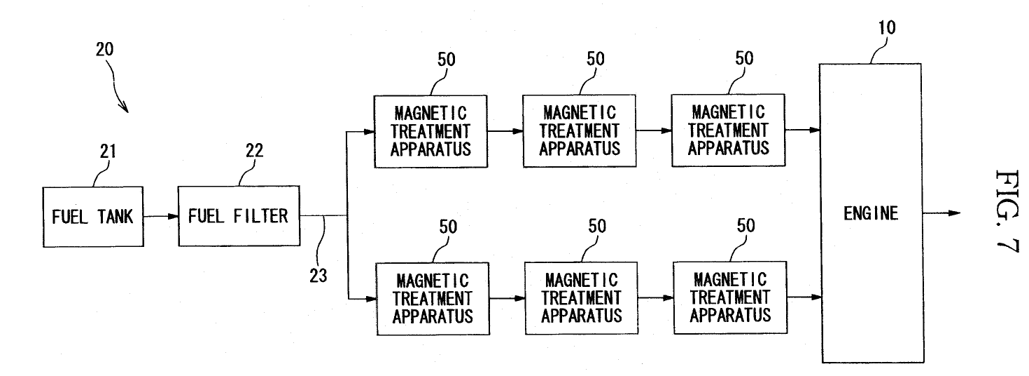

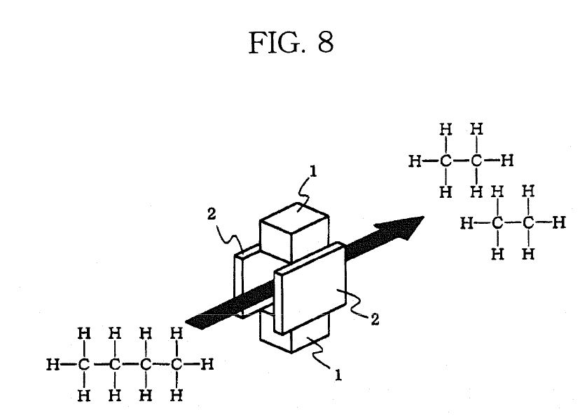

The yoke 54 is formed of a ferromagnetic metal such as iron, and covers the side surface and the rear surface of the permanent magnet 52. In this embodiment, the yokes 54 at the opposed positions are disposed in the separated state, but as shown in FIG. 6, the yokes 54 at the opposed positions may be integrated and formed into a square shape. Since the magnetic circuit with closed loop is constructed by the yoke 54a in this manner, the magnetic flux is doubled, and leakage of magnetic flux is suppressed to be able to enhance the efficiency of magnetic treatment. In this case, if a clearance of 1 to 2 mm is provided between the pipe 51 and the permanent magnet 52, the magnetic flux passes through the pipe 51 more easily and efficiency of the magnetic treatment is enhanced.

The magnetic shield 55 is formed by using a ferromagnetic metal such as iron, and covers a plurality of magnet pairs 53 at a predetermined space. Therefore, even when a number of strong permanent magnets 52 with a high magnetic flux density are provided, the leakage magnetic flux is absorbed by the magnetic shield 55, and the magnetic treatment apparatus 50 with less magnetic flux leakage can be constructed.

The magnetic shield 55 of this embodiment is formed by using a pair of ferromagnetic metal plate materials 55a which are bent to be U-shaped in section. Namely, a pair of ferromagnetic metal plate materials 55a formed to be U-shaped in section are disposed to be butted to each other to be oblong in section, and thereby, and they covers the entire periphery of the magnet pair 53. Therefore, it becomes possible to form the magnetic shield 55 by simple work by using the less expensive ferromagnetic metal plate material 55a such as an iron plate.

The casing 56 is constructed by including a base part 56a, and a cover part 56b which covers the pipe 51, the magnet pairs 53, the magnetic shield 55 and the like which are provided on the top of it. The base part 56a and the cover part 56b are both formed by a nonmagnetic resin material such as FRP (fiber reinforced plastic), and cover the magnet pairs 53 and the magnetic shield 55 at a predetermined space. Therefore, even if the apparatus is mounted to a location near a ferromagnetic substance, the problem of the magnetic circuit in the apparatus being short-circuited does not occur, and magnetic flux leakage can be reliably prevented.

Further, the apparatus is placed near the engine part of an automobile or a ship which a man does not approach, and therefore, coupled with the action of the above described magnetic shield 55, it does not exert an adverse effect on a human body, even if the magnet which generates magnetic flux with a high density is used.

When the magnetic treatment apparatus and the magnetic treatment system of the present invention are carried out in a medium-sized or a large-sized engine for a ship or power generation, a plurality of magnetic treatment apparatuses can be arranged in series and/or in parallel. FIG. 7 shows the state in which the magnetic treatment apparatuses are mounted to a large-sized engine, and two sets of the magnetic treatment apparatuses, each set constituted of the three magnetic treatment apparatuses disposed in series, are provided in parallel.

### EXAMPLE

The effects of the magnetic treatment apparatuses 50 and the magnetic treatment system using them were verified by using a truck (four tons) loaded with a diesel engine. In the comparative example, the truck traveled without being mounted with the magnetic treatment apparatus 50, and in the example, the truck traveled with the magnetic treatment apparatuses 50 mounted to the fuel supply line 23 and the air intake line 32.

In the comparative example, the truck traveled 5043 km for 25 days, the fuel used (light oil) was 1059 L, and the average fuel consumption was 4.76 km/L.

Meanwhile, in the example, the truck traveled 7433 km for 45 days, the fuel used was 1228 L. The average fuel consumption was 6.05 km/L, and the fuel consumption was reduced by 27.1% as compared with the comparative example.

Next, the result of the measurement test of the particulate matter (PM) when the magnetic treatment apparatus for an engine of the present invention was actually attached to the automobile is shown.

The measurement test was conducted by measuring the amount of PM emission from the engine before and after the apparatus of the present invention (magnetic treatment apparatus for an engine) is attached, in Japan Automobile Transport Technology Association.

As a result, the result as shown in the following Table 2 was obtained.

TABLE 2

| | PM EMISSION | |
|---|---|---|
| | AMOUNT | REDUCTION |
| | (g/kwh) | RATE (%) |
| BEFORE ATTACHING THE | 0.578 | — |
| APPARATUS | | |
| AFTER ATTACHING THE | 0.425 | 26.7 |
| APPARATUS (ONE) | | |
| (TWO IN SERIES) | 0.382 | 33.0 |
| (THREE IN SERIES) | 0.358 | 38.1 |

As shown above, the magnetic treatment system and the magnetic treatment apparatus of the present invention was effective in reduction of the emission amount of PM. The reduction rate of the emission amount of PM was the value which met the standard of Tokyo Metropolitan Government of the fiscal year of 2004.

### INDUSTRIAL APPLICABILITY

The magnetic treatment apparatus for an engine and the magnetic treatment system for an engine of the present invention can enhance magnetic reactions of fuel and intake air and can enhance the efficiency of magnetic treatment by causing magnetism to act intermittently on the fuel and the intake air when magnetically treating the fuel passing through the fuel supply line and the intake air passing through the air intake line, and therefore, they are applicable to the engines for an automobile, a ship, power generation and the like.

1. A magnetic treatment apparatus for an engine which is provided in a fuel supply line and/or an air intake line of an engine, and performs magnetic treatment for fuel passing through said fuel supply line and/or intake air passing through said air intake line, comprising:
a magnet pair comprising a pair of magnets opposed to each other with said fuel supply line and/or said air intake line therebetween, and generating magnetic flux in a direction substantially perpendicular to a flow of the fuel and/or the intake air; and
a casing covering said magnet pair,
wherein said casing accommodates a plurality of said magnet pairs; and
wherein said magnet pairs are disposed along said fuel supply line and/or said air intake line at predetermined spaces by which said magnet pairs intermittently apply a magnetic action.

2. The magnetic treatment apparatus for an engine according to claim 1,
wherein said magnets are disposed to be opposed to each other at both sides of a pipe made of a nonmagnetic material in the fuel supply line and/or the air intake line of the engine.

3. The magnetic treatment apparatus for an engine according to claim 1, wherein a side surface and a rear surface of said magnet are covered with a yoke formed of a ferroelectric metal.

4. The magnetic treatment apparatus for an engine according to claim 1, wherein said magnets are covered with a magnetic shield.

5. The magnetic treatment apparatus for an engine according to claim 1, wherein said magnet is a rare-earth permanent magnet having a residual magnetic flux density of 10000 gausses or more.

6. The magnetic treatment apparatus for an engine according to claim 5,
wherein the residual magnetic flux densities of said magnet pairs are made substantially the same.

7. The magnetic treatment apparatus for an engine according to claim 2, wherein said magnet pairs are disposed at spaces each of which is twice to ten times as large as a diameter of said pipe.

8. The magnetic treatment apparatus for an engine according to claim 2, wherein a width of said magnet is larger than a diameter of said pipe.

9. The magnetic treatment apparatus for an engine according to claim 1, wherein said magnetic shield is formed by using a ferromagnetic metal plate material which is bent to be U-shaped in section.

10. The magnetic treatment apparatus for an engine according to claim 1, wherein said casing is formed of a nonmagnetic resin material.

11. A magnetic treatment system for an engine,
wherein the magnetic treatment apparatus for an engine according to claim 1 is provided in the fuel supply line of an engine and/or the air intake line of the engine.
